(19) United States
(12) Patent Application Publication
(10) Pub. No.: US 2026/0075348 A1
(43) Pub. Date: Mar. 12, 2026

(54) EARBUD SECURING DEVICE ASSEMBLY AND METHOD OF USE

(71) Applicant: MICHAEL ABRAHAMSON, MUNSTER, IN (US)

(72) Inventor: Michael Rose Abrahamson, Chicago, IL (US)

(21) Appl. No.: 18/708,726

(22) PCT Filed: Nov. 8, 2022
(86) PCT No.: PCT/US2022/049210

§ 371 Date: May 9, 2024

Related U.S. Application Data
(60) Provisional application No. 63/278,738, filed on Nov. 12, 2021.

(51) Int. Cl. H04R 1/10

(52) U.S. Cl. CPC H04R 1/105; H04R 1/1016; H04R 2460/17

(57) ABSTRACT

An earbud and earbud securing device assembly and method of use assist an earbud user with difficulties faced while using an earbud, such as when the earbud becomes displaced within an ear of the earbud user or falls out of the ear. The earbud and earbud securing device assembly includes a first loop configured to wrap around the ear and a second loop configured to couple to the earbud. An earbud kit includes earbuds, an earbud case storing the earbuds, and earbud securing device assemblies that may be supported by the earbud case. A method of securing and storing earbuds uses the earbud and earbud securing device assembly. Moreover, if the earbuds and the earbud securing device assembly are displaced in a dark environment, one or more of these devices may emit a photo-luminescent glow so that the earbuds and any component of the earbud securing device assembly can be readily found in the dark.

### RELATED APPLICATION

This application claims the benefit of U.S. Provisional Application No. 63/278,738 titled “Device and Method of Use for Securing Earbuds to Ears” to Michael Abrahamson, filed Nov. 12, 2021, the entire disclosure of which is expressly incorporated by reference herein.

### TECHNICAL FIELD

The present disclosure relates generally to an earbud securing device assembly and method of use for the earbud securing device assembly. More particularly, this disclosure relates to an earbud securing device assembly and method of use for the earbud securing device assembly wherein an earbud securing device secures an earbud to an ear of an earbud user.

### BACKGROUND

This section introduces aspects that may help to facilitate a better understanding of the disclosure. Accordingly, these statements are to be read in this light and are not to be understood as admissions about what is or is not prior art.

Many people use earbuds to listen to recorded audio, listen to another person speak, or to cancel out noise. An earbud is placed in an ear of an earbud user. More specifically, a speaker of the earbud is placed in the ear. While using the earbud, earbud users often face difficulties during which the earbud becomes displaced within the ear or falls out of the ear. This may cause the earbud user to lose the earbud or to have to reposition the earbud within the ear.

### SUMMARY

According to the present disclosure, an earbud and earbud securing device assembly is provided. The assembly comprises an earbud having a speaker and an anchor coupled to the speaker. The assembly further includes an earbud securing device having an earbud support configured to support the earbud on an ear of an earbud user, a first magnetic object coupled to the earbud support, and a second magnetic object configured to magnetically couple to the first magnetic object.

According to another aspect of the present disclosure, a method of securing and storing earbuds is provided. The method includes a step of providing an earbud securing device configured to secure an earbud to an ear of an earbud user. The earbud has a speaker and an anchor coupled to the speaker. The method further includes a step of providing an earbud case, a step of coupling the earbud securing device to the anchor of the earbud, a step of placing the earbud on the ear of the earbud user, a step of coupling the earbud securing device to the ear of the earbud user, a step of uncoupling the earbud securing device from the ear of the earbud user, a step of removing the earbud from the ear of the earbud user, a step of positioning the earbud in the earbud case, and a step of supporting the earbud securing device with the earbud case.

According to an additional aspect of the present disclosure, an earbud kit is provided. The earbud kit comprises earbuds, an earbud case storing the earbuds, and elastic earbud securing devices configured to support the earbuds on ears of an earbud user. The elastic earbud securing devices are supported by the earbud case.

### BRIEF DESCRIPTION OF DRAWINGS

The description of the figures refers to the Earbud Securing Device Assembly and the method of use of varied embodiments of this invention so as to secure different shapes and sizes of earbuds:

FIG. 1 depicts a first version embodiment of the earbud securing device (“first version”) as an earbud user would wear this version of the earbud securing device, to accommodate the earbud depicted in FIG. 1 as depicted as a lateral view of the earbud user's ear (“lateral view”).

FIG. 2a depicts certain components of the first version and each component is enumerated in FIG. 2a, specifically components numbered: 13, 14, 17, and 19, whereas FIG. 2b depicts a second version of an embodiment of the earbud securing device (“second version”) by depicting component numbered 14′, 13 and FIG. 2c depicts a third version embodiment of the earbud securing device (“third version”) and depicts components labeled 13 and 14. How each of the preceding components are integral to each of the three specified embodiments (first version, second version, and third version) depicted in FIGS. 2a, 2b, and 2c is further elucidated when cross-referencing FIG. 1, FIG. 4, and FIG. 5; depicting different types and sizes of earbuds, in the earbud user's ear.

FIG. 3 depicts each of the following: an earbud case, the first version earbud securing device, and two earbuds; one for the earbud user's left ear and one for the right ear. The first version embodiment of the earbud securing device is also captioned in FIG. 1 (and in FIG. 2a). Collectively FIG. 3 depicts the “first version earbud kit”.

FIG. 4 depicts the second version embodiment of the earbud securing device as an earbud user would wear this second version of the earbud securing device, to secure the earbud depicted, and it should be noted that the earbuds depicted in FIG. 1, FIG. 4, and FIG. 5 are styled and sized differently hence the invention teaches and depicts in FIG. 2a, FIG. 2b, and FIG. 2c the exemplary three version embodiments, of the earbud security device; to effectively secure each of the three differing earbuds (FIGS. 1, 4, 5) into and upon the earbud user's ear for optimal use.

FIG. 5 depicts the third version embodiment of the earbud securing device as an earbud user would wear this third version of the earbud securing device, to secure the earbud depicted.

FIG. 6 depicts the first version embodiment of the earbud securing device as an earbud user would wear this first version of the earbud securing device, to secure the earbud depicted.

FIG. 7 depicts each of the following: an earbud case, two earbuds; one for the left ear and one for the right ear of the earbud user, and the second version embodiment, of the earbud securing device, captioned in FIG. 1 and captioned in FIG. 2b. Collectively FIG. 7 depicts the second version earbud kit.

FIGS. 8a and 8b are anterior and posterior views, respectively, depicting the second version embodiment of the earbud securing device secured to the outside of the earbud case.

FIG. 9 is a flow chart showing a method for affixing the earbud securing devices to earbuds, securing the earbud securing devices and their affixed earbuds to ears, unfastening the earbud securing devices from the ears and from earbuds, affixing earbud security devices to the outside of the earbud case and means of supporting them to stay affixed to the earbud case, storing the earbud securing devices with earbuds inside of an earbud storage kit, and various means of storing the earbud securing devices of FIGS. 2a, 2b, and 2c.

FIG. 10 depicts an earbud securing device as described herein being used to secure a set of earbuds to a cell phone for storage.

FIG. 11 depicts an earbud securing device as described herein being used to secure an earbuds case or kit to a cell phone for storage.

### DETAILED DESCRIPTION

For the purposes of promoting and understanding the principles of the disclosure, references will now be made to the embodiments illustrated in the drawings, which are described below. The embodiments disclosed below are not intended to be exhaustive or limit the disclosure to the precise form disclosed in the written description. Rather, the embodiments are chosen and described so that others skilled in the art may utilize their teachings. Unless otherwise indicated or apparent, the components shown in the figures are proportional to each other. It will be understood that no limitation of the scope of the disclosure is thereby intended. The disclosure includes any alterations and further modifications in the illustrative devices and described methods and further applications of the principles of the disclosure, which would normally occur to one of skill in the art to which the disclosure relates.

### DETAILED DESCRIPTION OF DRAWINGS

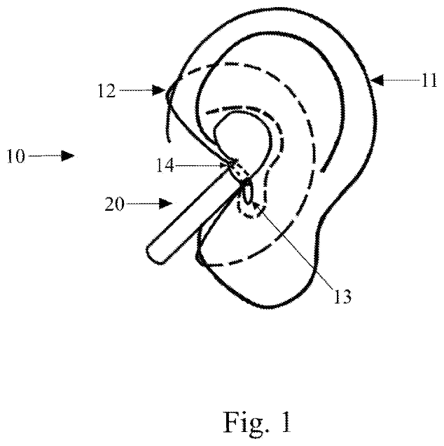

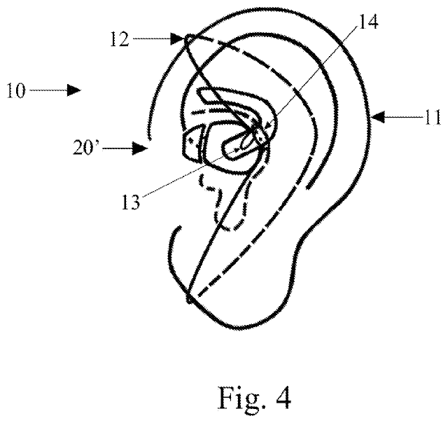

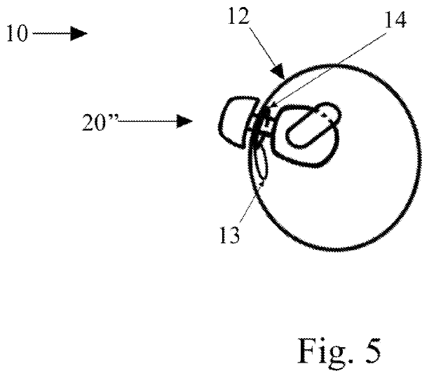

FIG. 1 depicts and discloses a first version earbud securing device 10 including a loop 12 and a loop 14, as seen in FIG. 1, to aid an earbud user in securing earbud 20 to an ear 11 of the earbud user. The first version earbud securing device 10 prevents loss and damage to the first earbud 20. Additionally, the first version earbud securing device 10 eliminates the earbud user's need to reposition earbud 20 in ear 11. The first version earbud securing device 10 may be used with earbud 20 (FIG. 1), earbud 20′ (FIG. 4), and earbud 20″ (FIG. 5) as described, referenced and depicted in accompanying Drawings and herein. The first version earbud securing device 10 may be used with other earbud sizes, configurations, and variations, apart from the different earbuds depicted (FIGS. 1, 4, and 5).

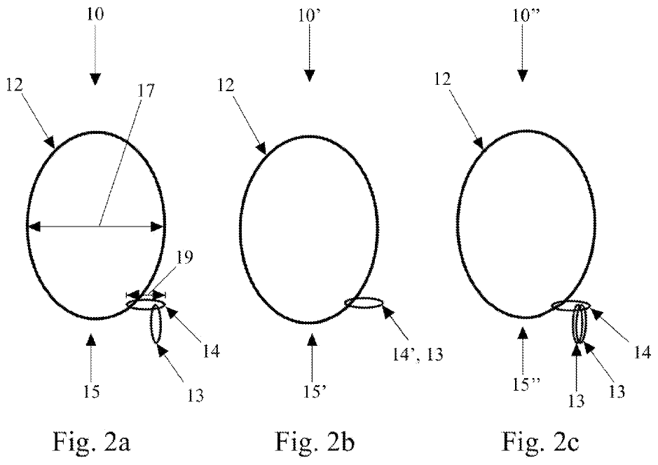

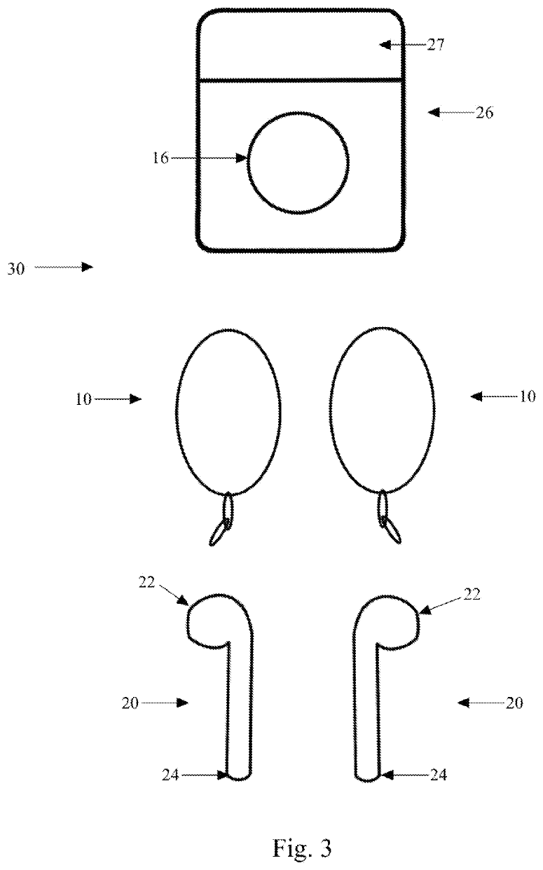

FIG. 1 illustrates the first version earbud securing device 10 in use by the earbud user to secure earbud 20 to an ear 11. As depicted in FIG. 3 the first version earbud 20 includes a speaker 22 and an anchor 24 coupled to speaker 22. Anchor 24 may be configured differently on different earbuds as informed herein. For example, on the Apple® AirPod® earbud, anchor 24 is an earbud microphone stem. FIG. 1 depicts the first version earbud securing device 10. FIG. 2a reveals detailed components of the first version earbud securing device 10 (FIG. 1) and depicts the following components: an earbud support 15, and a magnetic object 13. FIG. 3 depicts a second magnetic object 16 affixed to the anterior outer surface of the earbud case. Earbud support 15, is the first version embodiment of the earbud security device necessary to support earbud 20 on the ear 11. FIG. 2a depicts components of the earbud support 15, which includes a loop 12 and a second loop 14. FIG. 1 teaches and depicts that the loop 12 wraps around the ear 11 and is supported by the ear 11 (FIG. 1). FIG. 1 cross-referenced with FIG. 3 together depict and are illustrative of an embodiment in which the loop 12 is supported by the ear 11 (FIG. 1), the speaker 22 of the earbud 20 is secured inside of the ear 11 (FIG. 1 and FIG. 3) and the loop 14 is supported by the loop 12 and is positioned on the anchor 24 of earbud 20 (FIG. 1 and FIG. 3).

As illustrated in FIG. 1 and FIG. 2a, the loop 12 and the loop 14 may be made of an elastomer or elastic fiber such as Spandex® elastic material, making it possible for the earbud user to remove the first version earbud securing device 10 in a single motion. The loop 12 and the loop 14 have a high extensibility (500% to 700%), a low elastic modulus (200% elongation, 0.04 to 0.12 g/denier), and high elastic recovery (200% elongation, 95-99% recovery).

FIG. 1 depicts a preferred embodiment, wherein the first version earbud securing device 10 is devoid of more than two loops formed of elastic material. In additional alternative embodiments, the loop 12 (FIG. 1) may be provided with various tensile strengths to fit the ear 11 to accommodate different sizes and morphology of ears of earbud users.

In alternative embodiments, the first loop 12 and the second loop 14 are manufactured to include a photo-luminescent material, which enables the earbud securing device 10 to photo-luminesce, after being exposed to any light for a short period of time exciting the phosphorescent/photo-luminescent material therein (loops 12 and 14). Here, upon withdrawal of the light source, the earbud securing device 10 has a propensity to emit light in a totally dark or dimly lit environment and to maintain visibility of the earbud securing device 10, to the earbud user, and visibility of the earbud securing device 10 to anyone, in the dark, or in a dimly lit environment. In additional alternative embodiments, the loop 12 is adjustable to various sizes to provide a customized fit to the ear 11 to accommodate usage by all earbud users.

In one embodiment, the loop 12 is a full loop that is uninterrupted. In an alternative embodiment, the loop 12 is a partial loop, such as a hook.

FIG. 2a depicts a first version of the earbud securing device 10. FIG. 2b depicts a second version of the earbud securing device, designated 10′. FIG. 2c depicts a third version of the earbud securing device, designated 10″. FIG. 2a, designated 10, FIG. 2b, designated 10′, and FIG. 2c designated 10″ depict three different embodiments of the earbud securing device while not affixed to the earbud user's ear. In FIG. 2a, earbud securing device 10 consists in pertinent part of, and depicts the earbud support 15, and the component magnetic object 13, coupled to the earbud support 15. FIG. 2a, depicts the first version of the earbud securing device designated 10, and includes, in pertinent part, the earbud support 15, the first loop 12, and the second loop 14.

FIG. 2a depicts that the loop 12 has a relaxed diameter 17 and that the loop 14 has a relaxed diameter 19, providing relaxed perimeters thereof. Depicted in FIG. 2a and designated 10, is the first version embodiment, which teaches and reveals that the relaxed diameter 17 of loop 12 is at least three times larger than relaxed diameter 19 of second loop 14. FIG. 2b, which depicts the second version of the earbud securing device, also depicts the loop 12 as does FIG. 2c, depicting the third version of the earbud securing device, and FIGS. 2a, 2b and 2c depict the relaxed diameter of loop 12 marked as element 17 in FIGS. 2a, 2b, and 2c. The loop 14, depicted in FIG. 2a and FIG. 2c, has the same relaxed diameter in both FIG. 2a and FIG. 2c. FIG. 2b depicts the component loop 14′ which has a relaxed diameter of 19. As previously noted above, FIGS. 2a, 2b, and 2c depict three different versions of the earbud securing device, and each version or embodiment is configured to attach to different styles and sizes of earbuds. FIGS. 1, 4, and 5 depict three entirely different and distinguishable earbuds (specifically with respect to the size and the configurations of each earbud) with the three different versions of the earbud security device being attached to each distinguishable earbud. FIGS. 2a, 2b, and 2c depict each of three versions or embodiments of the invention, when the loop 12 is not affixed to any earbud and is not affixed to the earbud user's ear(s). It should be noted that each earbud securing device depicted in FIGS. 2a, 2b, and 2c, respectively labeled 10, 10′ and 10″, illustrates how the earbud user fastens each earbud securing device to one earbud (e.g., to the three different earbuds depicted in FIG. 1, FIG. 4 and FIG. 5) and all earbud security devices depicted, labeled 10, 10′, and 10″, are interchangeable between left ear and right ear designed earbuds.

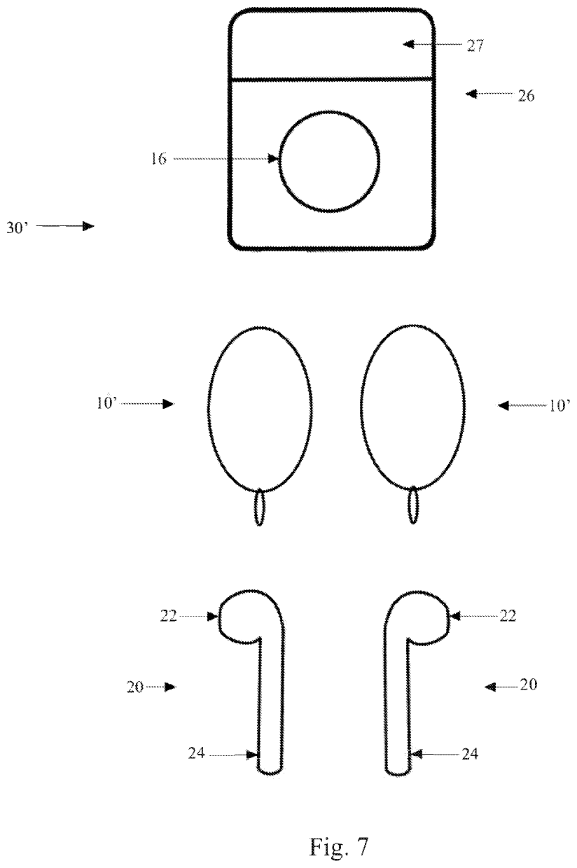

FIG. 7 depicts Apple® AirPod® earbuds. FIG. 2b, (depicting a second version of the earbud securing device) is configured to secure the Apple® AirPod® earbuds in FIG. 7 to the earbud user's ears. FIG. 2b depicts the loop 14′, 13, with a relaxed diameter of 9 millimeters. FIG. 7 depicts AirPod® earbuds that will efficaciously accommodate insertion of the earbud's microphone stem, labeled 24 into the component loop 14′, 13 of FIG. 2b, linked to the loop 12, wherein the loop 12 affixes to the ear. FIG. 1, depicts a preferred embodiment, which includes a second loop 14′, 13 which possesses a relaxed diameter 19 (FIGS. 2a and 2b) measuring 9 millimeters. This diameter is slightly larger than the anchor 24 (FIG. 3) of the Apple® AirPod® earbuds so as to couple to the anchor 24 of Apple® AirPod® earbuds. In alternative embodiments, the relaxed diameter 19 of the second loop 14′, 13 (FIG. 2b) may be larger or smaller than 9 millimeters, so as to couple to a variety of other earbud anchors. However, in other embodiments, the relaxed diameter 19 of the loop 14′ 13 (or other loops disclosed herein) could be in a range between 8.5 to 9.5 mm, 8 to 11 mm, 7 to 12 mm, or could be approximately 9 mm). This relaxed diameter may be based on the size of the user's ear and could come in one of a set of ranges or sizes, such as small, medium, large, extra-large, child, adult, teen, etc. Moreover, the elastic loops described herein can be of any suitable thickness.

FIG. 1 depicts the loop 12 as an integral component of the earbud securing device. The loop 12 and the ear 11 are depicted in FIG. 1. The loop 12 component is utilized as taught, and as depicted in FIG. 1. The loop 12 will have a stretched perimeter dependent upon the size of the earbud user's (users') outer ear 11. To accommodate users that have larger outer ears, the stretched perimeter of the loop 12 may be larger with respect to the stretched perimeter of the loop 12 for users that have smaller outer ears.

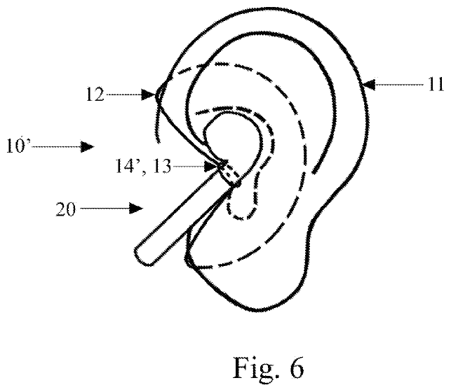

FIG. 2a depicts a first version of the earbud security device, referenced in the Drawings as 10. FIG. 2b, depicts a second version of the earbud security device and is referenced in the Drawings as 10′. The second version has each of the following components, including an earbud support component referenced as 15′, a first loop referenced as 12, a second loop referenced as 14′, 13 and which consists of a magnetic object having propensity for magnetic attraction to a component 16, and the component 16 as depicted in FIG. 3 and in FIG. 7. The second loop 14′, 13 is affixed to the loop 12 as depicted in FIG. 2b. FIG. 3 depicts an earbud referenced as 20 and an anchor for the earbud 20 referenced as 24. FIG. 2b, depicts the second version embodiment, and the second loop 14′, 13 is positioned on the anchor 24 (FIG. 3) to effectuate the second version embodiment. A common component, the magnetic object (e.g. a metal ring) referenced as 13 is a component of the first version, referenced as 10 (FIG. 2a) and the third version, referenced as 10″ (FIG. 2c). Additionally, the second version, referenced as 10′ (FIG. 2b) includes the second loop 14′, 13, and a magnetic object (e.g. a metal ring). The first, second and third versions (or embodiments) of the earbud securing devices each have respectively a second loop (i.e., loop 14 (FIG. 2a), loop 14′, 13 (FIG. 2b), and loop 14 (FIG. 2c) each of which couples to (or slides over) the anchor 24 of earbud 20 (FIG. 3) or can anchor any other earbuds captioned (FIG. 4, FIG. 5, FIG. 6) or can anchor other earbuds apart from those captioned and depicted herein.

FIG. 2c depicts a third version (embodiment) which includes, in pertinent part, the earbud supported (referenced as 15″), two magnetic objects (e.g. metal rings) referenced as 13, a loop 12, and a second loop 14. The two magnetic objects 13 are coupled to the second loop 14. The third version (FIG. 2c) has identical components to the first version (embodiment) (FIG. 2a) except that third version includes two first magnetic objects 13 instead of one first magnetic object 13 (e.g. metal rings). FIG. 3 depicts an earbud 20 which is coupled to an anchor 24. The second loop 14 is positioned on the anchor 24 of the first earbud 20 when the third earbud securing device 10″ is in use. The third earbud securing device 10″ is identical to first earbud securing device 10, except that third earbud securing device 10″ includes two first magnetic objects 13 instead of one first magnetic object 13.) As will be understood, the magnetic objects or rings 13 may anchor the loops 14 described herein to the stem of the earbud by being placed around the bottom end of the stem and slid upwards towards the speaker of the earbud. Of course, the rings 13 may have a diameter slightly larger than the diameter of the stem of the earbud. Moreover, the rings 13 may be sized and shaped to fit around the stem of the earbud, such that if the stem of the earbud is rectangular, oval or square, for example, the rings 13 could also be rectangular, oval or square to fit around the stem of the earbud. Moreover, it will be understood that the size and shape of the rings 13 can be based on or made to fit the stem of the earbud to which the earbud securing mechanism is made to fit. It will be understood that this sizing of the rings 13 is applicable to any of the embodiments disclosed herein.

FIG. 2a and FIG. 2c depict first version and third version embodiments, respectively referenced therein as 10 and 10″, with the magnetic object 13 (e.g. a metal ring) which is coupled to loop 14, which is coupled to loop 12 (loop 12 depicted in both FIG. 2a and FIG. 2b). FIG. 3 depicts the magnet 16 configured with an alloy of neodymium, iron and boron to form the Nd₂Fe₁₄B (or similar magnetic alloy components) magnet structure 16 with the propensity to magnetically couple (“magnet 16”) to first magnetic object 13 during storage of first version and third version earbud securing devices; respectively referenced and labeled as 10 and 10′ in FIGS. 2a and 2b.

FIG. 2b depicts: the second version embodiment, referenced therein as 10′, with the second loop 14′, 13 coupled to loop 12. FIG. 3 depicts the permanent magnet 16 configured with an alloy of neodymium, iron and boron to form the Nd₂Fe₁₄B (or similar alloy magnetic components) with the propensity to magnetically couple to second loop 14′, 13 during storage of second version earbud securing device; labeled as 10′.

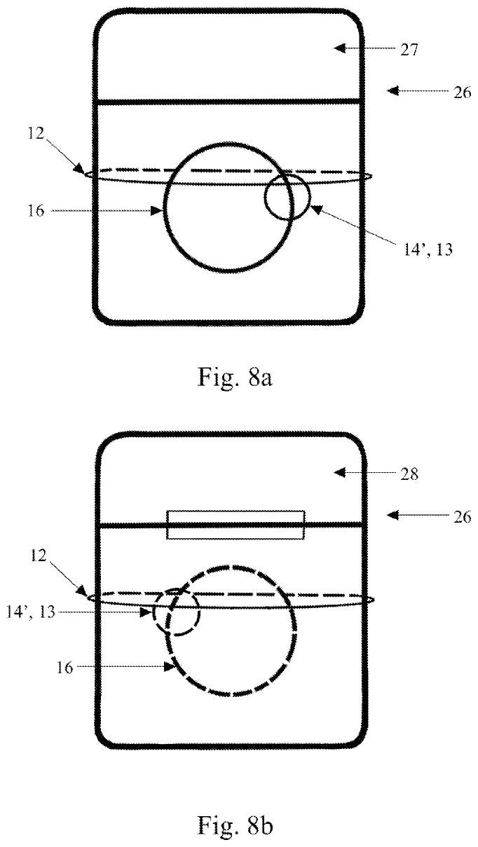

FIG. 3 depicts three separate components and collectively these three components are referred to as an “earbud kit” labeled as 30. The earbud kit 30 includes three components depicted from the superior aspect including earbud case 26, “first version” earbud securing device 10, and two earbuds 20. The earbud case 26, stores in its interior, earbuds 20. The earbud case 26 can also affix and store on its exterior surface labeled 27 one or several earbud security devices (FIGS. 2a, 2b, 2c labeled 10, 10′, 10″) when not in use for immediate fixation and immediate access by earbud users of the three version (embodiments) of the earbud securing devices 10, 10′, and 10″ (FIG. 2a, FIG. 2b, FIG. 2c respectively) without having to open earbud case 26 (“store earbud security devices”). In one embodiment, the magnet 16 is adhered, or as otherwise provided, on the exterior surface 27 of earbud case 26 for storage of the earbud security devices as taught herein. The magnet 16 includes on one side an adhesive backing (not shown) that the earbud user can then position and affix the magnet 16 to the exterior surface 27 of the earbud case 26 (FIG. 3). FIG. 1 depicts the earbud securing device 10 securing earbuds 20 when the user affixes the earbud securing device 10 on the ear 11 as taught herein. FIG. 8a and FIG. 8b depict the anterior aspect of earbud case 26 (FIG. 8a) and the posterior aspect of earbud case 26 (FIG. 8b) with the earbud securing device 10 having been affixed to the exterior surfaces (labeled as references 27, 28 of FIGS. 8a and 8b, of the earbud case 26 when the earbuds 20 (FIG. 7) are not being used by an earbud user. Storing of earbud security devices is accomplished by the earbud user stretching the loop 12 (FIGS. 2a, 2b, 2c) around the external surface of earbud case 26 (FIGS. 8a and 8b) and aligning the first magnetic object 13 (FIG. 2a and FIG. 2c) with the magnet 16 (FIG. 8a and FIG. 8b). The magnet 16 and the magnetic object 13 (e.g. metal ring) are magnetically attracted to one another to secure and store the earbud securing device 10 on the external surfaces of earbud case 26 (FIG. 2a, FIG. 2c, FIG. 8a, and FIG. 8b). Magnetic affinity of the magnetic object 13 for the magnet 16 provides security to maintain the earbud securing device 10 onto the exterior of earbud case 26. The loop 12 having been elasticity stretched around the exterior surface of earbud case 26, provides additional security to anchor and store the earbud security device 10 upon the external surfaces of earbud case 26 (FIG. 8a and FIG. 8b). FIG. 3 depicts the earbud kit 30 including the components of an earbud case 26, an earbud security device 10, and earbuds 20, collectively forming an earbud kit 30 (FIG. 3). FIG. 1, FIG. 4, and FIG. 5 depict three different earbuds; labeled with references 20, 20′, and 20″, respectively (“three different earbuds”). All three different earbuds can be associated with an earbud case 26 (FIG. 3) for internal storage therein, and said earbuds may be fastened by means of the earbud security device to earbud user's ear 11 (FIG. 1 and FIG. 4) when in use. Moreover, when the earbud security devices 10′ and 10″ (FIGS. 2b, 2c) are not in use, any earbud case configured to accommodate earbuds 10′ and 10″ for internal storage can facilitate and accommodate the three versions (embodiments) exemplified herein for storing earbud security devices 10, 10′, 10″ (FIGS. 2a, 2b, 2c) on the exterior surfaces of any earbud case: that is configured for different earbuds, exemplified and depicted in FIG. 4 and FIG. 5 (earbud case not shown).

Referencing FIG. 2a and FIG. 2c, the magnetic object 13 is a metallic ring made of one or more metallic alloys of: iron, cobalt, nickel, and their alloys (“metal alloys”), ferromagnetic material(s) having ferromagnetism affinity for the magnetic object 16, and this preferred embodiment of earbud security devices has a propensity to adhere to earbud cases as depicted in FIG. 8a and FIG. 8b. As depicted in FIG. 2a and FIG. 2c, an alternative embodiment is such that the metal alloys of object 13 (configured as a ring or similar) are manufactured to be a permanent magnet, and magnetic object 16 is also a permanent magnet. In this embodiment, the object 13 and the object 16 are both permanent magnets, both including ferromagnetic material(s) (“materials”) so that when the earbud user aligns the object 13 and the object 16 (also taught elsewhere herein), they adhere to the external surfaces of case 26 as depicted in FIG. 8a and FIG. 8b. The object 16 has on one side an adhesive backing and is affixed to the case 26 as depicted in FIGS. 8a and 8b. The Object 13 and the object 16 are then aligned by the earbud user such that their materials emit a magnetic field. The magnetic field includes “atomic moments” between the materials of the object 13 and the object 16, and so said materials exhibit strong interactions of ferromagnetic affinity to adhere to each other, and thereby the earbud user can readily cause synchronous instantaneous affixation of earbud security devices 10 and 10″ (labeled in FIG. 2a and FIG. 2c respectively) to secure earbud security devices to the case 26, and/or to the external surfaces 27 and 28 thereof (labeled in FIGS. 8a and 8b). The object 13 will affix to both the anterior and posterior surfaces of the earbud case 26 (labeled in FIGS. 8a and 8b). In an additional embodiment, the object 13 (depicted in FIG. 2a and FIG. 2c) is a permanent magnet, and the object 16 (FIG. 3) is a metal ring wherein the object 16 has ferromagnetism affinity for the permanent-magnet object 13. Additionally, further embodiments include objects labeled 13 and 16, with the object 13 depicted in FIGS. 2a and 2c and the object 16 depicted in FIG. 3, which cannot only be manufactured with different materials as stated, but can also be configured in shapes apart from that of a circular configuration.

The diagrams and figures in the Drawings of the invention teach and depict various embodiments of the earbud security devices that can be manufactured to affix to any earbud and teaching this in the invention there are three different sizes, configurations and versions of earbuds depicted in the drawings. These embodiments include FIG. 1 which depicts the Apple® AirPod® earbud, FIG. 4 which depicts the Apple® Beats Fit Pro® earbud, and FIG. 5 which depicts the Apple® Beats Studio Buds® earbud. FIG. 1 depicts the earbud 20, fastened to the securing device 10 (depicted in FIG. 2a); including the loop 12 and the object 13 (both depicted in FIG. 2a) secured to the anchor 24 (FIG. 3) whereby the earbud user inserts the anchor 24 into the object 13, thereby effectuating the loop 12 being secured to the earbud 20. Component speaker 22, of the earbud 20, (depicted in FIG. 3) is inserted into the ear 11 (FIG. 3) so that, thereafter, the earbud user expands loop 12 to wrap comfortably around the ear 11. The earbud user has hereby caused the earbud security device 10, to be securely anchored to the earbud 20, and the loop 12 to the ear 11, which effectuates one as depicted in FIG. 1. FIG. 4 depicts another embodiment wherein the earbud 20′ is fastened to the security device 10′ (depicted in FIG. 2b); including the loop 12 and the object 14′, 13 (both depicted in FIG. 2b) secured to the earbud 20′ which includes a superior wing in the outer ear concha (depicted in FIG. 4) whereby the earbud user inserts the earbud speaker of the earbud 20′ into the ring object 14′, 13, which in turn effectuates the loop 12 being secured to earbud 20′. The component speaker of earbud 20′ (depicted in FIG. 4) is inserted into the ear 11 (FIG. 4) and thereafter the earbud user expands the loop 12 to wrap comfortably around the ear 11. The earbud user has thereby caused the earbud security device 10′ (FIG. 2b) to be anchored to the earbud 20′, and the loop 12 to the ear 11, which effectuates another embodiment depicted in FIG. 4.

FIG. 5 depicts the earbud 20″ fastened to the earbud securing device 10′ (depicted in FIG. 2b), including the loop 12 and the object 14′, 13 (both depicted in FIG. 2b) secured to the anchor depicted between the speaker and the microphone of the earbud 20″ (“anchor”) depicted in FIG. 5 whereby the earbud user inserts the anchor into the loop object 14′, 13 thereby effectuating the loop 12 being secured to the earbud 20″. The component speaker of the earbud 20″ (depicted in FIG. 5) is inserted into the ear and thereafter the earbud user expands the loop 12 to wrap comfortably around the ear. The earbud user has hereby caused the earbud security device 10′ to be securely anchored to the earbud 20″ and the loop 12 to the ear thereby effectuating another embodiment depicted in FIG. 5. It should be noted that FIG. 5 does not depict the earbud security device and its associated earbud being secured upon the ear 11.

FIG. 6 depicts the earbud 20, fastened to the earbud securing device 10′ (depicted in FIG. 2b); including the loop 12 and a magnetic object 14′, 13 (“magnetic object”) (depicted in FIG. 2b). The magnetic object 14′, 13 is attached to the loop 12. Here, the earbud user inserts the anchor 24 into the magnetic object 14′, 13, thereby effectuating the loop 12 being secured to the earbud 20. The component speaker 22, of the earbud 20, (FIG. 3) is inserted into the ear 11 (FIG. 3) and, thereafter, the earbud user expands the loop 12 to wrap comfortably around the ear 11. In an embodiment of earbud securing device 10′, that the magnetic object 14′, 13 is a Neodymium type magnet ring (or similar) and as such can magnetically couple to, or have affinity to attach to other objects such as the object labeled 16, as depicted in FIG. 8a. The earbud securing device 10′ can secure many different sizes and configurations of earbuds as taught herein, including but not limited to the three different earbuds depicted in the drawings.

FIG. 7 depicts the second version earbud kit, earbud kit 30′, whereas FIG. 3 depicts the first version earbud kit, earbud kit 30: distinguishable from each other in that the earbud securing device 10′ (FIG. 2b and FIG. 7) is the earbud securing device of FIG. 7 whereas the earbud securing device 10 is the component earbud securing device of FIG. 3; wherein all other components of FIG. 3 and FIG. 7 remain constant or facsimiles of each other. The distinguishable earbud securing device 10 (FIG. 2a and FIG. 3) and the device 10′ (FIG. 2b and FIG. 7) have their own earbud kits wherein, when the device 10 and the device 10″ are not in use (fastened upon ear 11, FIG. 1) they can be secured and stored by the earbud user on the external surfaces of the earbud kit 30 (FIG. 3) and the earbud kit 30′ (FIG. 7). The embodiment of FIG. 7, includes individual components of an earbud kit 30′, an earbud securing device 10′, and two earbuds labeled 20 (for a left ear and a right ear of the earbud user). An earbud user, when not utilizing the device 10′ (FIG. 7), stretches and expands the loop 12 (FIG. 2b) to fit upon and snug the external surfaces labeled 26 and 27 (FIG. 7) of the earbud case labeled 26 (FIG. 7). Further, due to the elastic recoil of the loop 12 squeezing the earbud case 26 (FIG. 8a and FIG. 8b) upon the external surfaces labeled 27 and 28 of the case 26 (FIG. 8a and FIG. 8b), the metallic ring labeled object 14′, 13 (which may include ferromagnetic materials (FIG. 2b)) is positioned by the earbud user to be in close proximity to, or upon, the magnetic object labeled 16 (FIG. 7, FIG. 8a, and FIG. 8b) which object labeled 14′, 13 and object labeled 16 are within each other's magnetic field of attraction also causing the earbud securing device 10′ to fervidly secure the device 10′ upon the external surfaces labeled 27 and 28 of the earbud unit 26 (FIG. 7, FIG. 8a, and FIG. 8b). This is an embodiment as well as the fact that the other two different earbuds depicted (FIG. 4, and FIG. 5), and their respective earbud securing device (FIG. 2a and FIG. 2c), as taught elsewhere herein, have their own distinguishable earbud case, that is distinguishable from the objects labeled 30 and 30′ (FIG. 3 and FIG. 7). The instant embodiment described herein as it applies to the earbud 20 (FIG. 7) and its associated earbud security device object labeled 10′ and it's component loop 12 (FIG. 2b and FIG. 7) that operates to squeeze the earbud case 26 can be utilized with the two other earbuds depicted (FIG. 4 and FIG. 5), and with their associated earbud security devices (depicted in FIG. 2a and FIG. 2c), and their own earbud kits (not depicted). Further, the instant embodiment as it applies to the earbud 20 (FIG. 7) and its associated earbud security device object labeled 10′ and it's component loop 12 (FIG. 2b and FIG. 7) wherein the metallic ring labeled object 14′, 13 including ferromagnetic materials (FIG. 2b) is positioned by the earbud user to be in close proximity to, or upon, magnetic object labeled 16 (FIG. 7, FIG. 8a, and FIG. 8b) so that the object labeled 14′, 13 and the object labeled 16 are within each other's magnetic field of attraction also causing the earbud securing device 10′ to fervidly secure the device 10′ upon the external surfaces labeled 27 and 28 of earbud unit 26 (FIG. 7, FIG. 8a, and FIG. 8b). This embodiment can be utilized as it relates to the correlative components of both of the two other earbuds (depicted in FIG. 4 and FIG. 5) and as it relates to their associated earbud security devices (depicted in FIG. 2a and FIG. 2c), can be utilized with any earbud distinguishable from the earbud described in this embodiment, earbud labeled 20 (FIG. 7), and can be utilized as it relates to a distinguishable earbud's earbud security device described in this embodiment, earbud security device 10′ (depicted in FIG. 2b and FIG. 7).

At least three different embodiments are described herein. In particular, embodiment one, illustrated in FIG. 2b, depicts the loop 14′ which is a ferromagnetic metal ring and the object labeled 16 (FIG. 3, FIG. 7, FIG. 8a, and FIG. 8b) is a permanent magnet. Embodiment two, illustrated in FIG. 2b depicts loop 14′, 13 which is a permanent magnet and the object labeled 16 (FIG. 3, FIG. 7, FIG. 8a, and FIG. 8b) is a permanent magnet. Embodiment three, illustrated in FIG. 2b, depicts the loop 14′, 13 as a permanent magnet and the object labeled 16 (FIG. 3, FIG. 7, FIG. 8a, and FIG. 8b) is a metal ring. In still other embodiments, the rings 13 may be absent from the earbud securing device described herein. Instead, other securing mechanisms or methods may be used to secure the elastic loops 14 to the earbud. In one case, the elastic loops 14 may be wrapped around the earbud prior to the earbud being placed into the user's ear. In another case, the elastic loop 14 may be attached to the earbud with glue or other permanent or temporary adhesive. In a still further embodiment, a suction cup, or a sticky material, such as a rubber or polyurethane material, may be applied, fixed to or held onto the elastic loop 14 and this material may operate to stick to the earbud to hold the loop 14 onto the earbud when the earbud is disposed within the user's ear.

Two earbud kits are depicted and they include FIG. 3 which depicts an earbud kit labeled object 30 with its component parts, and FIG. 7 which depicts an earbud kit labeled object 30′ with its component parts. Kits labeled 30 and 30′ include their respective earbud security devices, labeled object 10 (FIG. 3) and labeled object 10′ (FIG. 7), earbud security devices 10 and 10′ can be secured upon the external surface labeled 27 of the component earbud case 26 (depicted in both FIG. 3 and FIG. 7) of kits 30 and 30′, as well as within the interior of kits 30 and 30′. Another embodiment includes an additional third earbud kit labeled and referenced as 30″ (not depicted) which includes component parts of a similar earbud case 26, two identical earbud securing devices 10″ (for each ear), and two earbuds including one for the left ear and one for the right ear. FIG. 4 depicts an earbud labeled as 20′ and secured upon the ear 11 by its earbud security device labeled 10 (depicted in FIG. 2a and FIG. 4). FIG. 5 depicts an earbud labeled as 20″ and affixed to its earbud security device labeled 10 (depicted in FIG. 2a and FIG. 4). The earbud kit 30″ (not depicted) is configured to have a component case similar to object labeled 26 (depicted in FIG. 3 and FIG. 7) to store an earbud 20 (FIG. 1), and an earbud 20′ (FIG. 4), and an earbud 20″ within interior kit 30″ (not depicted) and to store an earbud security device 10″ (FIG. 2c) upon kit 30″ (not depicted) with similar external surfaces labeled 27 and 28 (depicted in FIG. 8a and FIG. 8b).

FIGS. 8a and 8b depict a replica of the component case labeled 26 (FIG. 7) of earbud kit 30′ (FIG. 7) with a replica of an earbud securing device 10′ (FIG. 2b) stored upon the external surface 27 (FIG. 7) of earbud case 26 (FIG. 7). When the earbud security device 10′ (FIG. 2b) is not in use by earbud user, i.e., not securing the earbud 20 (FIG. 1) to the ear 11, the earbud user stretches the component loop 12 of earbud security device 10′ to fit over the exterior surface 27 and 28 (FIG. 8a and FIG. 8b) of the component case 26 (FIG. 8a and FIG. 8b) and the loop 12 recoils to its original tensile resting circumference/perimeter (before having been stretched by earbud user) to fit upon and to snug the external surfaces labeled 27 and 28 (FIG. 8a and FIG. 8b) of earbud case labeled 26 (FIGS. 8a and 8b). Further, due to the elastic recoil of the loop 12 squeezing the earbud case 26 (FIG. 8a and FIG. 8b) upon the external surfaces labeled 27 and 28 of the case 26 (FIG. 8a and FIG. 8b), the metallic ring labeled object 14′, 13 including one or more ferromagnetic materials (FIG. 2b) is positioned by the earbud user to be in close proximity to, or upon, the magnetic object labeled 16 (FIG. 7, FIG. 8a, and FIG. 8b) so that the object labeled 14′, 13 and the object labeled 16 are within each other's magnetic field of attraction also causing the earbud securing device 10′ to fervidly secure the device 10′ upon the external surfaces labeled 27 and 28 of earbud unit 26 (FIG. 8a, and FIG. 8b).

FIG. 8a depicts a case 26 with a magnetic object 16 affixed by means of an adhesive on the posterior aspect of magnetic object 16 and thereby affixed via said adhesive to case 26's anterior exterior surface 27. The immediately preceding embodiment includes a facsimile magnetic object of magnetic object 16 also with an adhesive on its posterior aspect, designated herein as object 16′ (not depicted), and thereby magnetic object 16′ is secured to the posterior surface 28 of case 26 (FIG. 8b). In another embodiment, another facsimile magnetic object of the magnetic object 16 with an adhesive on this magnetic object's posterior aspect, designated herein object 16″ may be provided. The magnetic object 16″ is affixed by means of its adhesive surface, to any surface, such as a refrigerator, desktop, gym bag, purse, briefcase, etc. The three earbud securing devices, 10, 10′, and 10″ (depicted in FIG. 2a, FIG. 2b, FIG. 2c) and their respective components affixed to the loop 12 (namely the objects 13, 14, (FIG. 2a) 14′, 13 (FIGS. 2b) and 13, 14 (FIG. 2c)), each have a metallic ring (described elsewhere) with ferromagnetic material in the ring (e.g. iron, cobalt, nickel, neodymium, or similar) with magnetic polarity to attract all other magnets depicted and described herein that are: magnetic object 16 (FIG. 8a) magnetic object 16′ (not depicted) and magnetic object 16″ (not depicted). Another embodiment includes the earbud case 26 (FIG. 3, FIG. 7, FIG. 8a, FIG. 8b) that can be stored upon the magnetic object 16″ (not depicted) which then allows the earbud case 26 to be stored safely by earbud user anywhere by means of case 26 with magnetic object 16 affixed (FIG. 8a), or by means of the case 26 with magnetic object 16′ affixed (not depicted) being placed in close proximity to magnetic object 16″. The object 16″ can be adhered by earbud user upon any surface, safely anywhere, by means of its adhesive on one side of object 16″ and the magnetic object 16 can be affixed to the anterior surface of case 26 (FIG. 8a) and the magnetic object 16′ (not depicted) can be affixed to the posterior surface of case 26 (FIG. 8b), so that both magnetic objects 16 and 16′ having magnetic affinity to attach to a magnetic object 16″ thereby enable the earbud user to anchor the earbud case safely anywhere.

In some cases, the earbud user may utilize a surface with an inherent magnetic propensity, such as the posterior surface of a cell phone 54, which may preferably be an Apple® iPhone (but which is exemplary only), but which may instead include the surfaces of any cellphone, refrigerator, desktop or similar item), to bind to the magnets 16 (depicted in FIG. 8a and FIG. 8b) or magnet 16′ (not depicted but described above and further below) to hold a set of earbuds and/or an earbud case 26 (of FIG. 3 for example) to the surface for storage. In another example, the earbud user may utilize the posterior surface of the iPhone, or any other cellphone or item with a magnetic surface to enable an earbud user to eliminate the need for magnetic object 16″ while still using the surface to secure the earbud (as depicted in FIG. 3 and FIG. 7—designed to accommodate earbud version one) and any other earbud kit types (such as earbud kits designed for the other earbud versions or embodiments described herein, such as those depicted in FIG. 1, FIG. 4, and FIG. 5).

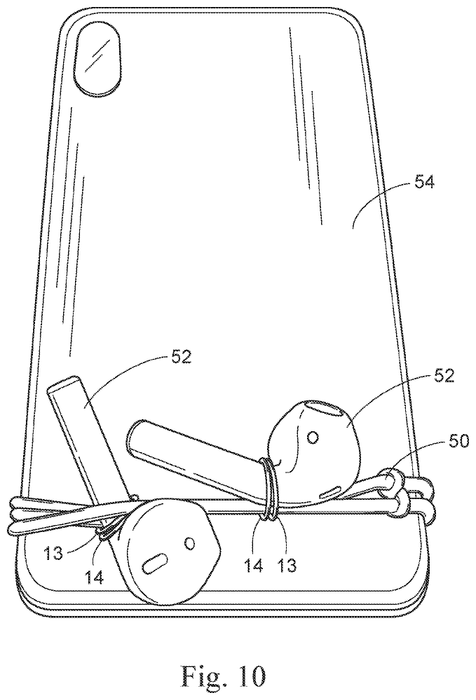

For example, the earbud user may use any of the earbud securing devices described and illustrated herein to store the earbuds or the earbud cases described herein on another object, such as on a cell phone or other similarly shaped object, or on other metallic objects. As an example, FIG. 10 depicts an earbud securing device 50, which may be any of the earbud securing devices described herein, being used to secure a set of earbuds 52 to a cell phone 54 for storage when not in use by the user. Here, the user may secure the rings 13, 14 of the earbud securing device to the earbud stems and then stretch the loop 12 of the earbud securing device around the cell phone 54 so as to use the force of the stretched loop 12 to hold the earbuds 52 onto the cell phone 54, again as depicted in FIG. 10.

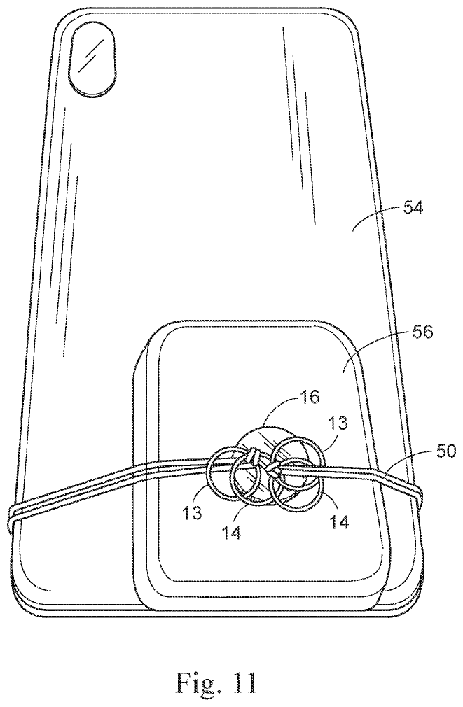

In a similar manner, FIG. 11 depicts an earbud securing device 50, which may be any of the earbud securing devices described herein, being used to secure an earbud case 56 (such as the earbud case 26 of FIG. 3) to a cell phone 54 for storage. In this case, the loops 12 of the earbud securing device may be stretched to fit around both the cell phone 54 and the earbud case 56 with the rings 13, 14 being placed on or magnetically connected to the magnets 16 of the earbud case 56. In this example configuration, the stretching action of the elastic loops 12 in combination with the magnetic attraction between the rings 13, 14 and the magnet 16 (on the earbud case 56) as well as the magnetic attraction between the magnet 16 (on the earbud case 56) and the metal surface of the cell phone 54 operate to secure both the earbud securing device 50 and the earbud case 56 to the cell phone 54.

In these examples, an Apple® iPhone (or the surfaces of any cellphone, refrigerator, desktop or similar item with a surface with an inherent magnetic propensity such as the posterior surface of the Apple® iPhone) may be used to secure all earbud securing devices 10, 10′, and 10″, with their object components depicted respectively in FIG. 2a, FIG. 2b, and FIG. 2c, and each earbud securing device (10, 10′, 10″) having inherent magnetic propensity to magnetically bind and adhere to the posterior surface of an Apple® iPhone (or to magnetic surface(s) of any cellphone, refrigerator, desktop, or similar item) and which surfaces of said items have an inherent propensity to magnetically bind to magnet 16 or magnet 16′. The earbud user can utilize the earbud kit(s) (as depicted in FIG. 3 and FIG. 7 or similar earbud kits for other earbud versions) and can have earbud securing devices 10, 10′, and 10″ be secured either inside their respective earbud kits (FIG. 3 and FIG. 7), or secured instead to their respective earbuds and then stored as illustrated and described herein (with respect to FIGS. 10 and 11, for example) to the posterior surface of an Apple® iPhone (or to surfaces of any similar cellphone) which posterior surface(s) of said cellphones or other objects of similar size have an inherent propensity to magnetically bind to the magnet 16 or the magnet 16′ (depicted in: FIG. 3, FIG. 7, FIG. 8a, FIG. 8b) and/or to magnetically bind to the object 13, to the object 14, to the object 14′ (depicted in FIG. 2a, FIG. 2b, and FIG. 2c) of earbud securing devices, when each of the earbud securing devices are not stored in the earbud case 26 (or similar earbud case or earbud kit).

It should be noted that the earbud user, when utilizing a surface with an inherent magnetic propensity, such as the posterior surface of an Apple® iPhone (which is the preferred embodiment) or the surfaces of any cellphone or similar item and when the earbud securing devices 10, 10′and 10″ (depicted in FIG. 2a, FIG. 2b, and FIG. 2c) are outside of the earbud case 26 and not in use by the earbud user, the earbud securing device 10 (depicted in FIG. 2a) may be secured by the earbud user stretching the component loop 12 of the earbud securing device 10 to fit over the exterior surfaces 27 or 28 (FIG. 8a and FIG. 8b) of earbud case 26 as illustrated in FIG. 11 (see also FIG. 8a and FIG. 8b) as well as to simultaneously fit over the outer posterior surface(s) of the iPhone (the exemplary surface of cellphone item with propensity for magnetically adhering to magnet 16 depicted in FIG. 8a and FIG. 8b or magnet 16′ not depicted/described above) of the iPhone. Here, the loop 12 recoils towards its original tensile resting circumference/perimeter (before having been stretched by earbud user) to fit upon and to snug the external surfaces labeled 27 or 28 of earbud case 26 (FIG. 8a and FIG. 8b). Further, due to the elastic recoil of loop 12 squeezing the earbud case 26 (FIG. 8a and FIG. 8b) upon the external surface labeled 27 or 28 of the earbud case 26 (FIG. 8a and FIG. 8b), the metallic ring labeled object 14′, 13 including one or more ferromagnetic materials (FIG. 2b) is positioned by the earbud user to be in close proximity to, or upon, the magnetic object labeled 16 (FIG. 7, FIG. 8a, and FIG. 8b) so that the object labeled 14′, 13 and the object labeled 16 are within each other's magnetic field of attraction also causing the earbud securing device 10 to fervidly secure device 10 upon the external surface(s) of each of the iPhone and the earbud case 26 (depicted in FIG. 8a, and FIG. 8b) as illustrated in FIG. 11. Thus, the earbud case 26 is not only magnetically attracted to the external posterior surface of the iPhone and secured upon the iPhone magnetically, the earbud securing device 10 (depicted in FIG. 2a) when not in use by the earbud user is now also used to further secure the earbud case 26 upon the external posterior surface(s) of the iPhone (with also the tensile recoil of the spandex/elastomer object 12 depicted in FIG. 2a)—apart from the magnetic affinity of the iPhone to earbud case 26 or a similar earbud case. Thus, the earbud user may simultaneously secure the earbud case 26 and the earbud securing device 10 (FIG. 2a) onto the external surfaces of both the iPhone and the earbud case 26 to avoid both the earbud case 26 and earbud securing devices (10, 10′, 10″) from being lost by an earbud user because the earbud case 26 is magnetically disposed onto the posterior surface(s) of the iPhone (or similar cellphone item or other surfaces) while simultaneously using the tensile recoil of elastomer loop 12 (FIGS. 2a, 2b, 2c) to be wrapped around the iPhone that has the earbud case 26 (FIG. 8a, FIG. 8b) magnetically adhering to the posterior surface(s) of the iPhone (or similar cellphone and surfaces). It should be noted that earbud securing device 10′ (FIG. 2b), and device 10″ (FIG. 2c) can be configured similarly as described above pertaining to the immediately preceding of exemplary device 10 (FIG. 2a) which is the earbud securing device of earbud version one (depicted in FIG. 3).

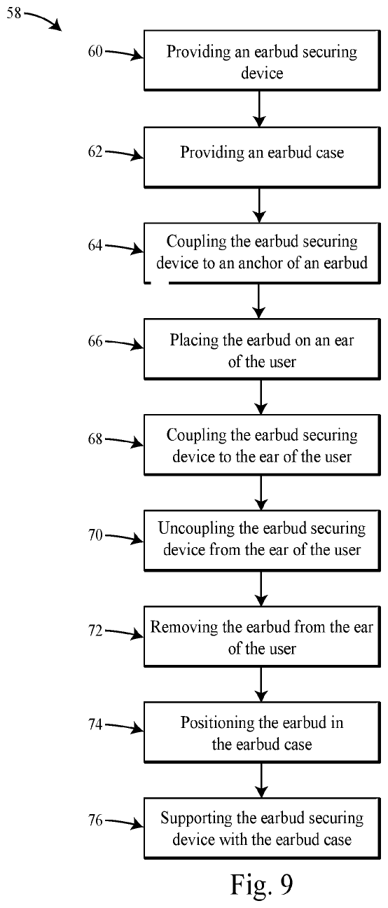

Thus, as will be understood, and as illustrated in FIG. 10, the earbud user has the option of storing the earbud securing device 10, device 10′, device 10″ (respectively FIG. 2a, FIG. 2b, and FIG. 2c) when not in use by the earbud user by affixing version one of the earbud described herein, object 20 (FIG. 3) to the earbud securing device 10 (FIG. 3), wherein the object 13 and object 14 (FIG. 2a) slide over microphone object 24 to be anchored by the speaker object 22 (FIG. 3) and then the earbud user can stretch the loop 12 of the object 10 (FIG. 2a) over the external outer surfaces of an iPhone (or similar cellphone item or other surfaces) with a propensity to magnetically adhere/affix to and store the earbud securing devices 10, 10′ and 10″ with its respective version one earbud, version two earbud and version three earbud fastened thereto, and then each of the three earbud securing device types (10, 10′, and 10″) with their earbuds (respectively version one, two and three) are stored upon an iPhone or similar cellphone (or similar item) by means of the magnetic affinity of the earbud securing devices objects 14, 13 (FIG. 2a), objects 14′, 13 (FIG. 2b) objects 14, 13 (FIG. 2c) for the posterior surface(s) of an iPhone (or similar cellphone item and surfaces) and/or by means of the force applied by the elastic loop 12. Object 13 and object 14 and the loop 12 are component objects of the earbud securing device 10 (all depicted in FIG. 2a) and are fastened upon the first version earbud (depicted in FIG. 3) as described herein and as illustrated in the figures, such as with object 58 and object 64 (depicted in FIG. 9). Object 13, object 14, (depicted in FIG. 2a) and object 22 (depicted in FIG. 3) all have inherent propensity to magnetically affix to the posterior surface(s) of an iPhone (or similar cellphones and surfaces described herein).

Moreover, as depicted in FIG. 11, when the earbud securing devices 10, 10′ and 10″ are not stored within the earbud case 26 or similar earbud case, they can be stored when not in use by the earbud user upon the external surface(s) of both the earbud case 26 (or similar earbud cases or earbud kits) and upon external surface(s) of an iPhone (or similar cellphone item or other surfaces) and while simultaneously securing the earbud case 26 (or similar earbud case or earbud kit) upon the user's iPhone (or similar cellphone item or other surfaces) by the tensile recoil of the object 12 (a component object of securing devices 10, 10′ and 10″ all depicted with their component objects in FIGS. 2a, 2b, and 2c) over the external surface(s) of both the iPhone and earbud case 26 (depicted in FIGS. 8a and 8b) or over any earbud case or earbud kits for the earbuds depicted in FIG. 1, FIG. 4, and FIG. 5.

Another embodiment enables an earbud user, when not using any of the earbud security devices 10, 10′ and 10″ (FIG. 2a, FIG. 2b, FIG. 2c), to also safely anchor any and all of the earbud security devices when not utilizing them and when earbud user desires to anchor any of the earbud security devices 10, 10′ and 10″ upon the magnetic object 16″ (not depicted), in that the metallic ring component object 13, 14 (FIG. 2a) and object 14′,13 (FIG. 2b) and the object 13, 14 (FIG. 2c) of each earbud security device 10, 10′ and 10″ all have magnetic affinity to attach to magnetic object 16″ (not depicted). As such, the earbud user can easily, quickly, and safely store any earbud security device away from the interior or exterior of the earbud case 26 (FIG. 3, FIG. 7, FIG. 8a, FIG. 8b) anywhere upon magnetic object 16″.

At least three different versions of the earbud security device with earbud securing devices depicted in FIGS. 2a, 2b, and 2c, respectively labeled 10, 10′ and 10″, illustrate how the earbud user fastens each earbud securing device to one earbud for each ear and the three different earbuds are depicted in FIG. 1, FIG. 4, and FIG. 5. When the earbud user is not using any of the earbud security devices, all of the devices 10, 10′ and 10″ (FIGS. 2a, 2b, and 2c) may be stored upon the anterior exterior surface 27 of case 26 (FIG. 8a) by means of magnetic object 16 (FIG. 8a) or upon the posterior exterior surface 28 of case 26 (FIG. 8b) by means of magnetic object 16′ (not depicted). All of the earbud security devices 10, 10′ and 10″ (FIGS. 2a, 2b, and 2c) have magnetic affinity for all magnetic objects referenced and depicted herein, namely magnetic objects 16, 16′, and 16″, by means of each of their magnetic object being attached to the loop 12 having magnetic affinity for magnetic objects 16, 16′, and 16″ as described herein.

FIG. 9 diagrammatically shows a method of securing and storing earbuds 58 of first earbud securing device 10, as also described herein. Method 58 begins with an initial providing step 60 by providing first earbud securing device 10 configured to secure first earbud 20 to ear 11. First earbud 20 that is provided in initial providing step 60 includes a speaker 22 and an anchor 24 coupled to speaker 22. Next, an earbud case 26 is provided in a case providing step 62.

FIG. 9 sequentially denotes each of the following steps. In particular, a step 64 describes earbud securing devices 10 (FIG. 2a) being coupled to an anchor 24 of the earbud 20 (FIG. 3) and the earbud support 15 of the earbud securing device 10 is coupled to the anchor 24 of the earbud 20. Step 66 denotes that the earbud user next places the earbud 20 (FIG. 3) in the ear 11. Step 68 includes the earbud user utilizing the component loop 12 of the earbud securing device 10 (FIG. 2a) to stretch the loop 12 comfortably over the ear 11.

FIG. 9 sequentially further denotes each of the following steps wherein Step 70 captions that the earbud user, when not using the first earbud 20 (FIG. 3), stretches the component loop 12 of the earbud security device 10 (FIG. 2a and FIG. 3) to comfortably remove earbud device 10 from ear 11. Step 72 denotes the earbud user then removing the earbud 20 from the ear 11. Step 74 denotes the earbud user placing the earbud 20 in the inside of the earbud case 26 for storage.

In FIG. 9, at Step 76, the earbud user stores and supports the earbud securing device 10 by means of the following: the component loop 12 of the earbud securing device 10 (FIG. 2a) is stretched by the earbud user to be affixed to the exterior surfaces 27 and 28 of the earbud case 26 and the magnetic object 13 (e.g. metallic ring) is placed in close proximity or upon the magnetic object 16 or magnetic object 16′ that is affixed by earbud user to exterior surfaces 27 and 28 of earbud case 26 (FIG. 8a and FIG. 8b). In another embodiment, the earbud user may place the earbud 20 in the interior of earbud case 26 without the earbud securing device (FIG. 3). Here, the earbud securing device 10, after being detached from the earbud 20, is securely affixed to the exterior surfaces 27 and 28 of the earbud case 26 by the earbud user stretching the component loop 12 of the earbud securing device 10 and the loop 12 recoils upon the exterior surfaces 27 and 28 of earbud case 26 (FIG. 8a and FIG. 8b). In another embodiment, the earbud security devices 10 and 10″ are left attached to the earbud 20′ (FIG. 4) and the earbud 20″ (FIG. 5) by means of the component loop 14 (FIG. 2a and FIG. 2c) being left attached to the anchor 24 of the earbuds 20′ and 20″ (FIG. 4 and FIG. 5) and earbud security devices 10 and 10″ (FIG. 2a and FIG. 2c) while attached to earbuds 20′ and 20″ are inserted by earbud user into the interior of earbud case 26.

FIG. 9 denotes the method 58 which encompasses step 64 and other embodiments including when the earbud user wants to use the earbud 20 and the earbud securing device 10 again, the user may remove earbud securing device 10 from storage around earbud case 26 by expanding loop 12 to facilitate removal of the earbud securing device 10. If the earbud securing device 10 is stored in the earbud case 26, the earbud user may open the earbud case 26 and remove the earbud 20 and the earbud securing device 10 from earbud case 26. Then, the earbud user can couple the earbud securing device 10 to the anchor 24 of the earbud 20, corresponding to earbud coupling step 64 of method 58 as described herein. The earbud user may then continue with method 58.

Method 58 may be used with earbud securing device 10′ (FIG. 2a) and earbud securing device 10″ (FIG. 2b). Method 58 may also be used with earbud 20′ (FIG. 4) and earbud 20″ (FIG. 5).

What is claimed is:

1. An earbud and earbud securing device assembly comprising:
an earbud having:
a speaker, and
an anchor coupled to the speaker,
an earbud securing device having:
an earbud support configured to support the earbud on an ear of an earbud user,
a first magnetic object coupled to the earbud support, and
a second magnetic object configured to magnetically couple to the first magnetic object.

2. The earbud and earbud securing device assembly of claim 1, wherein the earbud support includes a first loop configured to wrap around the ear of the earbud user and a second loop supported by the first loop and coupled to the anchor of the earbud.

3. The earbud and earbud securing device assembly of claim 2, wherein a relaxed diameter of the first loop is at least three times larger than a relaxed diameter of the second loop.

4. The earbud and earbud securing device assembly of claim 2, wherein the first loop has a first stretched diameter configured to wrap around a first user's ear, and a second stretched diameter configured to wrap around a second user's ear, the second stretched diameter is larger than the first stretched diameter, and the second user's ear is larger than the first user's ear.

5. The earbud and earbud securing device assembly of claim 2, wherein the first loop and the second loop are made of elastic material.

6. The earbud and earbud securing device assembly of claim 2, wherein the device is devoid of more than two loops made of elastic material.

7. The earbud and earbud securing device assembly of claim 2, wherein the first loop and the second loop are uninterrupted.

8. The earbud and earbud securing device assembly of claim 1, wherein the anchor of the earbud is positioned in the earbud support.

9. The earbud and earbud securing device assembly of claim 1, wherein the earbud support is made of elastic material.

10. The earbud and earbud securing device assembly of claim 1, wherein the earbud support includes a first loop configured to be supported by the ear of the earbud user, and the first loop supports the first magnetic object.

11. The earbud and earbud securing device assembly of claim 10, wherein the first magnetic object receives the anchor of the earbud.

12. The earbud and earbud securing device assembly of claim 1, wherein the earbud securing device includes a material having photoluminescence properties.

13. The earbud and earbud securing device assembly of claim 12 wherein the earbud support includes the material having photoluminescence properties.

14. The earbud and earbud securing assembly of claim 12, wherein the first or second magnetic object includes a material having photoluminescence properties.

15. A method of securing and storing earbuds including:
providing an earbud securing device configured to secure an earbud to an ear of an earbud user, the earbud having a speaker and an anchor coupled to the speaker
providing an earbud case;
coupling the earbud securing device to the anchor of the earbud;
placing the earbud on the ear of the earbud user;
coupling the earbud securing device to the ear of the earbud user;
uncoupling the earbud securing device from the ear of the earbud user;
removing the earbud from the ear of the earbud user;
positioning the earbud in the earbud case; and
supporting the earbud securing device with the earbud case.

16. The method of claim 15, further including a step of providing a magnetic object, wherein the magnetic object supports the earbud securing device during the supporting the earbud securing device step.

17. The method of claim 15, further including a step of uncoupling the anchor of the earbud from the earbud securing device before the positioning the earbud in the earbud case step.

18. The method of claim 17, further including a step of positioning the earbud securing device around the earbud case during the supporting the earbud securing device step.

19. The method of claim 15, further including a step of placing the earbud securing device inside the earbud case during the supporting the earbud securing device step.

20. The method of claim 15, wherein the earbud securing device is coupled to the anchor of the earbud during the supporting the earbud securing device step.

21. The method of claim 15, wherein the earbud securing device includes a material having photoluminescence properties.

22. The method of claim 15, further including a step of positioning the earbud securing device and/or the earbud case around a further object during the supporting the earbud securing device step.

23. The method of claim 22, wherein the further device comprises a cell phone.

24. The method of claim 22, wherein the step of positioning the earbud securing device around a further object and the earbud case comprises stretching the earbud securing device to fit around the further object and the earbud case.

25. The method of claim 22, wherein the step of positioning the earbud securing device and/or the earbud case around a further object includes aligning a magnetic element of the earbud securing device with the further object or the earbud case having an external surface area which possesses an inherent magnetic propensity to emit a magnetic field.

26. The method of claim 22, wherein the step of positioning the earbud securing device around a further object and the earbud case includes aligning a metal element of the earbud securing device with a magnet on the earbud case.

27. The method of claim 15, further including a step of positioning the earbud securing device around a further object during the supporting the earbud securing device step.

28. The method of claim 27, wherein the further device comprises a cell phone.

29. The method of claim 27, wherein the step of positioning the earbud securing device around a further object comprises stretching the earbud securing device to fit around the further object.

30. An earbud kit comprising:
earbuds,
an earbud case storing the earbuds, and
elastic earbud securing devices configured to support the earbuds on ears of an earbud user and the elastic earbud securing devices being supported by the earbud case.

31. The earbud kit of claim 30, wherein the elastic earbud securing devices include a first magnetic object supported by the earbud case.

32. The earbud kit of claim 31, wherein the earbud kit further includes a second magnetic object with an adhesive on one side to affix a second magnetic object on an exterior surface of the earbud case, the second magnetic object configured to magnetically couple to the first magnetic object.

33. The earbud kit of claim 31, wherein the earbud kit further includes a third magnetic object with an adhesive on one side to affix a third magnetic object on an exterior surface of the earbud case, the third magnetic object configured to magnetically couple to the first magnetic object.

34. The earbud kit of claim 31, wherein the earbud kit further includes a fourth magnetic object, with an adhesive on one side to affix a fourth magnetic object on any surface, the fourth magnetic object configured to magnetically couple to the first magnetic object, the second magnetic object, and the third magnetic object.

35. The earbud kit of claim 30, wherein the earbud securing devices include a material having photoluminescence properties.
